(19) United States
(12) Patent Application Publication
(10) Pub. No.: US 2026/0342714 A1
(43) Pub. Date: Oct. 29, 2026

(54) TRANSLATING MULTICAST TRACE REQUESTS BETWEEN MULTICAST GROUP ADDRESSES

(71) Applicant: HEWLETT PACKARD ENTERPRISE DEVELOPMENT LP, Spring, TX (US)

(72) Inventors: Tathagata Nandy, Bangalore (IN); Chethan Chavadibagilu Radhakrishnabhat, Bangalore (IN); Subramanian Muthukumar, Bangalore (IN)

(21) Appl. No.: 19/252,000

(22) Filed: Jun. 27, 2025

(30) Foreign Application Priority Data
Apr. 29, 2025 (IN) 202541041248

(51) Int. Cl. H04L 45/16; H04L 45/02; H04L 45/76

(52) U.S. Cl. CPC H04L 45/16; H04L 45/02; H04L 45/76

(57) ABSTRACT

A network device may include circuitry that receives a multicast trace request associated with a first multicast group address and incorporates identifying information associated with the network device in the multicast trace request. The circuitry may also query one or more routing tables of the network device to determine a group translation between the first multicast group address and a second multicast group address as well as upstream neighbor data associated with an upstream neighbor device along a data path that includes multiple network devices between a data source and a data client. The upstream neighbor device may be associated with the second multicast group address. The circuitry may also incorporate translation information regarding the group translation between the first multicast group address and the second multicast group address in the multicast trace request and send the multicast trace request to the upstream neighbor device.

### BACKGROUND

Computer networks such as local area networks (LANs) and wide area networks (WANs) connect multiple network devices for communications therebetween. Additionally, different network protocols may be utilized by the network devices for use as common sets of instructions to accommodate data transmissions. In some instances, a multicast protocol may be utilized for transmitting information from one or more sources (e.g., network device(s)) to multiple clients (e.g., other network devices).

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an example multicast trace performed in a network that provides communications between a source and a client and incorporates translation information for group translation between multicast groups, in accordance with aspects of the present disclosure;

FIG. 2 is a schematic diagram of an example multicast trace performed on a virtual extensible local area network a first multicast group of an overlay and a second multicast group of an underlay, in accordance with aspects of the present disclosure;

FIG. 3 is a table of example metadata of a multicast trace request at different network devices along a data path incorporating translation information between a first multicast group address and a second multicast group address, in accordance with aspects of the present disclosure;

FIG. 4 is a flowchart of an example process for implementing a multicast trace with translation/conversion information between multicast group addresses, in accordance with aspects of the present disclosure;

FIG. 5 is a schematic diagram of an example multicast trace that incorporates translation information between multicast group addresses and performed on a bidirectional network with a rendezvous device, in accordance with aspects of the present disclosure; and

FIG. 6 is a flowchart of an example process for implementing a multicast trace in a bidirectional network to incorporate translation information between multicast group addresses by converting a unicast multicast trace request into one or more multicast trace packets sent upstream from a rendezvous point, in accordance with aspects of the present disclosure.

### DETAILED DESCRIPTION

Computer networks may utilize trace operations to trace data paths between network devices. For instance, a multicast trace (Mtrace) may capture overlay and underlay information. Mtrace may be compatible with bidirectional rendezvous points (RPs) that act as meeting places of sources and receivers of multicast data. For example, such RPs may be part of a bidirectional protocol-independent multicast (Bidir-PIM) network. Multicast operations may conserve bandwidth by reducing the number of transmissions from the source(s) and using common data paths from the sources to the clients with Mtrace enhancing such operations by mapping data paths between source(s) and client(s). However, Mtrace may provide incomplete mapping in some topologies including Bidir PIM (e.g., virtual extensible local area networks (VxLANs)) due to Mtrace's bottom-up protocol structure and being unable to track routers upstream of the RP (e.g., between the RP and source(s)) due to the reliance on an upstream neighbor address and the lack of Mtrace in being able to track devices in different multicast groups between underlay and overlay transitions.

In more specific detail, Mtrace may be performed by generating, at an Mtrace client (e.g., network device), an Mtrace query which is sent to a network device as a last-hop-router (LHR) of that client. The LHR of a client is the last network device in a pathway from the source to the client. The Mtrace request may proceed upstream from the LHR back towards the source by tracking a multicast group address through an internet protocol (IP) network to another network device as a first-hop-router (FHR) of the client. The FHR is the first network device in the pathway from the source to the client. As should be appreciated, the IP network may include any suitable topology such as a VxLAN topology. In some implementations, the LHR may identify an immediate upstream neighbor (e.g., an intermediate network device) from which data was received that is associated with the multicast group address, such as via a routing table lookup. In response to receiving the Mtrace request, the upstream neighbor of the LHR may incorporate metadata associated therewith and identify itself to the Mtrace request and forward the updated Mtrace request to the next upstream neighbor along the data path until the FHR is reached. The completed Mtrace request (e.g., Mtrace reply), such as achieved at the FHR, may incorporate information regarding the LHR, FHR, and the nodes (e.g., network devices) traversed by the Mtrace request therebetween. Moreover, if the FHR is not also the Mtrace client, the Mtrace reply may be forwarded from the FHR to the Mtrace client.

As described above, Mtrace generally provides a mapping for network devices between the LHR and the FHR for the multicast group address. However, as noted above, the mapping may be incomplete in some topologies. For example, in a VxLAN topology, the multicast group address may be different for a portion of the nodes between the LHR and FHR. Indeed, a VxLAN topology includes an overlay, including the LHR and the FHR, and an underlay, including network devices for efficient routing, such as spine routers. However, the data path utilizing the multicast group address tunnels through the underlay such that an Mtrace request following the multicast group address may skip identification of network devices in the underlay. For example, certain network devices in the overlay may operate as VxLAN tunnel endpoints (VTEPs) that change the multicast group address to an underlay group address used in the underlay. The Mtrace request may tunnel through the underlay to another VTEP encountered when the data path emerges from the underlay back into the overlay, and the VTEP may change the underlay group address back to the original multicast group address. Moreover, network devices of the underlay may not recognize the original multicast group address of the Mtrace request and, as such, may not incorporate metadata or its identifying information thereto. As such, troubleshooting a multicast path in a VxLAN topology may incur additional challenges as the full end-to-end mapping may incomplete.

In accordance with some implementations, to address the complications of using Mtrace with VxLAN topologies, a network device may receive a Mtrace request with a first multicast group address. In response to receiving the Mtrace request, the network device may incorporate its own identifying information into the request. The network device also queries one or more routing tables to determine a group translation between the first multicast group address and a second multicast group address. The query also determines an upstream neighbor associated with the second multicast group address. As such, to incorporate the underlay network devices in the Mtrace, the Mtrace request may cause the VTEPs to identify, such as via a routing table lookup, different group addresses that may be mapped to the group address of the incoming Mtrace request. For example, a VTEP that transitions the Mtrace request from the overlay to the underlay may determine, when receiving the Mtrace request, the underlay group address that maps to the first multicast group address from the overlay and incorporate the underlay group address in the Mtrace request as part of its upstream neighbor identification using the second multicast group address. This translation information between the group addresses due to the overlay is incorporated into the Mtrace request. This updated multicast trace address with the incorporated translation information is sent to the determined upstream neighbor.

As such, upstream neighbors of the VTEP within the underlay may receive and respond to the Mtrace request in recognition of the underlay group address identified in the Mtrace request. Moreover, responding to the Mtrace request may include incorporating metadata and identifying information into the Mtrace request before forwarding the Mtrace request to the next upstream neighbor until reaching the FHR. As part of this process, at the VTEP that transitions the Mtrace request from the underlay to the overlay, the multicast group address that is mapped to the underlay group address in the routing table of the VTEP may be identified and incorporated into the Mtrace request as translation information such that network devices of the overlay may be identified as the Mtrace request proceeds through the overlay. As such, a more complete mapping of the data path between the LHR and the FHR through both underlays and overlays may be obtained via Mtrace.

In general, the above Mtrace techniques may be used to build mappings of communication pathways in Protocol-Independent Multicast (PIM) domains, such as sparse mode (PIM-SM). Indeed, some implementations using rendezvous points (RPs), in a PIM-SM network are unidirectional such that the upstream neighbors (e.g., previous-hop nodes) are known. However, in bidirectional PIM (Bidir-PIM) networks, there may be multiple sources with upstream neighbors of an RP being unknown. In other words, information that would be provided to the RP from the upstream neighbor regarding itself may be absent (e.g., empty field) from the Mtrace, as there may be a lack of a single path from which data flows. As such, network devices between a source and an RP may not be directly traceable via Mtrace based on path information known at the RP.

To perform an Mtrace in a Bidir-PIM network, the Mtrace request may start as a unicast trace packet and operate as set forth above regarding overlay and underlay translations. However, at an RP where upstream neighbor data is absent, the unicast trace packet may be converted to multicast trace packets that are addressed to all routers interfacing with the RP via the multicast group address. In other words, when the network device is an RP, discovering the upstream neighbor identifies multiple upstream neighbors from an RP, In this situation, the network device then converts the multicast trace packet of the Mtrace request from a unicast packet to one or more multicast trace packets. The network device then sends (e.g., floods) the one or more multicast trace packets upstream to the one or more (incoming) interfaces of the multicast routes for the second multicast group address.

Network devices that receive a multicast trace packet of the Mtrace request may incorporate (e.g., by appending) metadata identifying itself to the Mtrace request and direct (e.g., flood) multicast trace packets of the updated Mtrace request to all incoming interfaces of the multicast routes installed for the multicast group address, and the multicast trace packets will continue branching until reaching a network device (e.g., network access switch) of a source. For example, network devices receiving the multicast packets may determine that a source has been reached based on Link Layer Discover Protocol (LLDP) traffic, which occurs between routers, but not at the interface of a source. Once a source (e.g., FHR) is identified/reached, the network device of the source may convert the multicast trace packet of the Mtrace request to a unicast packet of an Mtrace reply and send the Mtrace reply to the Mtrace client (e.g., querying network device) that started the Mtrace. The Mtrace client may collate Mtrace replies received for the multicast group address and build the Mtrace mapping.

As should be appreciated, the Mtrace techniques discussed above with regard to a bidirectional network may also be utilized with the above techniques regarding identifying network devices in the underlay of a network. For example, an RP may identify a different multicast group address that maps to the multicast group address of the Mtrace request, incorporate the new multicast group address to the Mtrace request, and direct (e.g., flood) multicast trace packets of the updated Mtrace request to all incoming interfaces of the multicast routes installed for the new multicast group address.

Additionally, as noted above, the network devices traversed by the Mtrace request may incorporate metadata such as identifying information (e.g., IP address, device name, type of device, upstream neighbor address). In some implementations, the Mtrace request may query the network devices for additional information to assist in the detection of anomalies and for troubleshooting. For example, the Mtrace request may be incorporated with IP protocol information, packet transmission/reception (Tx/Rx) counters, access control list (ACL)/boundary configurations, and/or ping information. Moreover, anomalies may be flagged for faster troubleshooting.

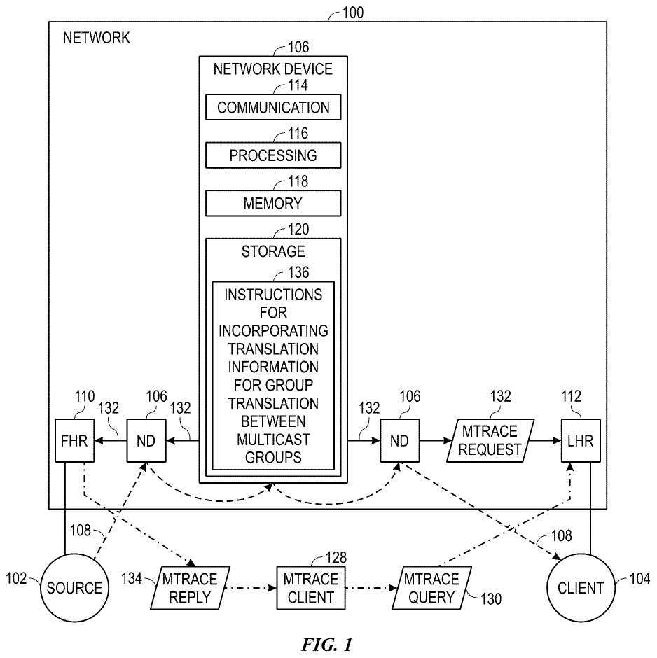

FIG. 1 is a schematic diagram of a network 100 that provides communications between a source 102 and a client 104 that may be mapped using Mtrace. For example, the source 102 may provide information and/or digital services to the client 104 via the network 100. As should be appreciated, the network 100 may be an internet protocol (IP) network and include any suitable network topology such as one or more LANs, one or more WANs, and/or one or more virtual extensible local area networks (VxLANs) to name a few.

Additionally, the network 100 may include one or more network devices (e.g., routers, switches, modems) that facilitate the transmission of data between the source 102 and the client 104 including one or more intermediate network devices 106. Further, as used herein, a first network device of the network 100 in a data path 108 from the source 102 to the client 104 is the first-hop-router (FHR) 110. In other words, the FHR 110 is the closest network device in relation to the source 102 along the data path 108 and in the network 100.

A last network device of the network 100 in the data path 108 from the source 102 to the client 104 is the last-hop-router (LHR) 112. In other words, the LHR 112 is the closest network device in relation to the client 104 along the data path 108 and in the network 100. One or more intermediate network devices 106 are between the LHR 112 and the FHR 110. As should be appreciated, in some implementations, fewer or more intermediate network devices 106 may exist between the FHR 110 and the source 102 and/or between the LHR 112 and the client 104 than the two illustrated intermediate network devices 106. For example, network devices 106 may be intermediaries within a private network (e.g., via a virtual private network (VPN)), beyond a proxy server, and/or other network devices beyond the network 100. Furthermore, as used herein, the source 102 and client 104 may be and/or include one or more computing systems (e.g., data servers, end-user devices) and/or other network devices.

The network devices between the source 102 and the client 104 may include the FHR 110, the LHR 112, and/or the intermediate network devices 106. Any of these network devices between the source 102 and the client 104 may include any suitable network switch, router, and other multi-port device. In some implementations, these network devices may include a number of components to perform the various operations described herein. For example, these network devices may include communication circuitry 114, processing circuitry 116, memory 118, storage 120, and the like.

In some implementations, the communication circuitry 114 may include transceiver circuitry and/or IO ports for wired and/or wireless communications. As such, the transceiver circuitry may include wireless and/or wired transceivers and one or more antennas and one or more wired ports, such as Ethernet, powerline, coaxial, fiber optics, and/or other wired communication techniques. Furthermore, the communication circuitry 114 may work in tandem with the processing circuitry 116 to perform one or more operations.

As should be appreciated, the processing circuitry 116 may include any combination of general-purpose microprocessors, microcontrollers, digital signal processors (DSPs), field programmable gate array (FPGAs), programmable logic devices (PLDs), controllers, state machines, gated logic, application-specific integrated circuits (ASICs) or other discrete hardware components, dedicated hardware finite state machines, and/or other circuitry. The processing circuitry 116 may utilize specialized processors that provide acceleration via task offloading and, as such, may include co-processors or accelerators that provide acceleration to the one or more processors of the processing circuitry 116 in one or more operations (e.g., routing operations).

Moreover, the processing circuitry 116 may be coupled to the memory 118 and/or storage 120 to execute instructions and perform operations. The memory 118 and/or storage 120 may include one or more tangible, computer-readable media that may receive and/or store instructions for performing the techniques discussed herein. For example, the memory 118 may include any short-term workspace implemented using any suitable memory architectures, such as dynamic random-access memory (DRAM), static random-access memory (SRAM), and/or other persistent or non-persistent memories. The storage 120 may be any long-term non-volatile storage devices, such as hard drives, solid-state drives, optical drives, flash drives, and the like.

As discussed herein, the network 100 may provide for multicast operations to distribute data and/or provide services to multiple clients 104 from one or more sources 102. For example, the network 100 may implement a VxLAN network topology that allows multiple clients 104 to share a physical network without seeing each other's network traffic. Multicast protocols may provide efficient transmission of data from one source 102 to multiple clients 104 of a multicast group in a one-to-many configuration and/or enable data from multiple different sources 102 to be transmitted to the multiple clients 104 of the multicast group. For example, a multicast group address may define a joinable group of clients 104 that subscribe to and receive data from the source(s) 102 when the multicast group address is specified for traffic. Additionally, intermediate network devices 106 transmitting data along a data path 108 to a client 104 may associate data transmissions/receptions with the multicast group address to provide the data to those clients 104 belonging to the group. In general, multicast operations may conserve bandwidth by reducing the number of transmissions from the source(s) 102 and using the data paths 108 where applicable from the source(s) 102 to the clients 104.

To achieve better consolidation of transmissions along the data paths 108 to the different clients 104 and/or to support troubleshooting for end-to-end communications, a multicast trace (Mtrace) may be performed for at least one of the clients 104. Utilizing the techniques discussed herein, Mtrace enables the mapping of a communication pathway (e.g., data path 108) between a source 102 and a client 104 and can be used to improve communication efficiencies (e.g., bandwidth usage, latency) and/or troubleshooting of communication errors or degradation. For example, a source 102 may provide information, such as via multicast, to multiple clients 104, and an Mtrace for each client 104 may identify common nodes (e.g., intermediate network devices 106, FHR 110, LHR 112) in the network 100 between the source 102 and the clients 104. Using these maps, repeated data streams may be removed, thereby reducing bandwidth consumption, and/or shorter pathways may be implemented, thereby reducing latency. Furthermore, as the data path 108 is mapped via the Mtrace, metadata associated with communications between the nodes may be obtained and utilized for efficient troubleshooting.

In some implementations, an Mtrace may be initialized by an Mtrace client 128 that sends an Mtrace query 130 to the LHR 112 of a client 104. While Mtraces may be performed on multiple clients 104 in parallel and/or in series, the Mtrace for a single client 104 will be discussed herein for brevity. The Mtrace client 128 may be any suitable network device and may be associated with the source 102, the client 104, or a third party. For example, in some implementations, the FHR 110 of one or more source(s) 102, the LHR 112 of a client 104, or any other device may act as the Mtrace client 128. The Mtrace query 130 may be sent to the LHR 112 of the client 104, and an Mtrace request 132 may be generated by the LHR 112 and propagated through the network 100 to the FHR 110. As each upstream network device 106 receives the Mtrace request 132, the network device identifies the next upstream neighbor (e.g., relative to the data path 108 from the FHR 110 to the LHR 112), incorporates metadata identifying the network device to the Mtrace request 132, and forwards the updated Mtrace request 132 to the next upstream neighbor until the FHR 110 is reached.

The Mtrace request 132 may also specify a multicast group address and follow the data path 108 associated with distribution of data from a source 102 for that multicast group address back to the source 102 while incorporating metadata, such as identifying information (e.g., IP address, MAC address, and/or other identifying information), associated with the intermediate network devices 106 traversed between the LHR 112 and the FHR 110. For example, the LHR 112 may identify an intermediate network device 106 that is an immediate upstream neighbor from which data associated with the multicast group address was received. In some implementations, the Mtrace request 132 may cause the LHR 112 to perform one or more routing table lookups to identify the upstream neighbor based on the multicast group address. The LHR 112 may incorporate metadata or identifying information identifying itself to the Mtrace request and then forward the updated Mtrace request 132 to the next upstream neighbor. In some implementations, the LHR 112 and other intermediate network devices 106 that receive the Mtrace request 132 may also incorporate identifying information regarding the upstream neighbor to the Mtrace request 132 before forwarding the updated Mtrace request 132 to the upstream neighbor. The identification of the upstream neighbor, incorporating of metadata, and forwarding of the Mtrace request 132 may continue until the FHR 110 is reached. When the FHR 110 receives the Mtrace request 132, the FHR 110 may send the completed Mtrace request 132, as an Mtrace reply 134, to the Mtrace client 128. As such, the Mtrace client 128 may compile a mapping of the data paths 108 from the source(s) 102 to the clients 104 based on the Mtrace replies 134. However, as previously noted, in some scenarios, the multicast group address may change along the data path 108 such that certain network devices of the network 100 may be tunneled past, based on the original multicast group address, if the new multicast group address is not noted in the Mtrace request 132. As previously noted, this may occur when traffic is transferred between underlay and overlay networks.

In such situations, the network devices may store and execute instructions for incorporating translation information for group translation between multicast groups 136 stored in the storage 120. As such, the instructions incorporate translation information between multicast group addresses when such transfers exist between underlay and overlay networks. The instructions may be executed by the processing circuitry 116. For instance, the instructions 136 may be implemented at least partially in hardware, such as via an ASIC or other standalone circuitry. Additionally or alternatively, at least a portion of the functions of the instructions 136 may be implemented as instructions stored in memory 118 and/or storage 120 and executed by the processing circuitry 116. In other words, in some implementations, the instructions 136 may be implemented using hardware and/or software.

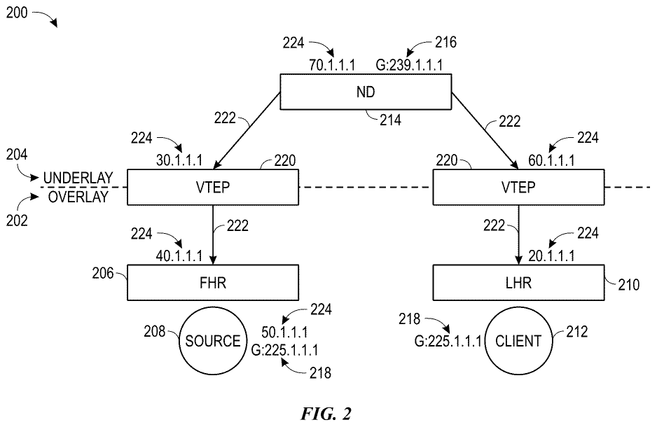

FIG. 2 is a block diagram showing an example VxLAN topology 200 that includes an overlay 202 and an underlay 204 that may each have their own multicast group addresses that are translated between when an Mtrace traverses the boundaries between the overlay 202 and the underlay 204. The overlay 202 may include client-side and source-side network devices, such as an FHR 206 associated with a source 208 and an LHR 210 associated with a client 212. The source 208 may be an example of the source 102 of FIG. 1, and the client 212 may be an example of the client 104 of FIG. 1. Likewise, the LHR 210 may be an example of the LHR 112 of FIG. 1, and the FHR 206 may be an example of the FHR 110 of FIG. 1.

Additionally, the underlay 204 may include one or more underlay network devices (NDs) 214 (e.g., spine routers) that provide structure to enable communications between portions of the overlay 202 that may not be part of the overlay 204. The underlay network device 214 may be an example of any suitable network devices, such as the intermediate network devices 106, the FHR 110, or the LHR 112 of FIG. 1. For example, the underlay network devices 214, such as spine routers, may provide efficient replication of data for distribution, which may improve network bandwidth usage by avoiding transmission of repeated extra copies of data packets. To achieve this, the underlay 204 utilizes an underlay group address 216 that is different from a multicast group address 218 of the overlay 202. In other words, although the source 208 and the client 212 are in the same multicast group address 218, communications between the source 208 and the client 212 may travel through other devices (e.g., the underlay network device 214) in one or more other underlay group addresses 216 that may be missed in the Mtrace.

In some implementations, VxLAN tunnel endpoints (VTEPs) 220, as part of the overlay 202 and the underlay 204, may provide for transitions between the underlay group address 216 and the multicast group address 218. For instance, the VTEPs 220 may be implemented on any of the network devices of FIG. 1, such as the intermediate network devices 106, the FHR 110, or the LHR 112 of FIG. 1. The VTEPs 220 may translate/convert between the underlay group address 216 and the multicast group address 218 by creating an effective tunnel through the underlay for the multicast group address 218 by encapsulating data packets in virtual packets that act as envelopes to transmit the packets through the underlay 204 to their intended destinations.

In some scenarios, underlay network devices 214 may be missing from Mtrace requests 222 that do not exhibit the underlay group address 216. Moreover, incomplete Mtrace results that lack the full data path (e.g., lack the underlay network devices 214) may cause difficulties in improving performance (e.g., bandwidth utilization and latency) and/or troubleshooting deployments such as isolating packet loss issues or latency delays. As such, when identifying the upstream neighbor in response to the Mtrace request 222, a VTEP 220 may determine that a group translation exists based on changed multicast group addresses. In other words, the VTEP 220 may identify a mapping/conversion as translation information between the multicast group address 218 of the Mtrace request 222 and the underlay group address 216, or vice versa. For instance, the VTEP 220 may use the instructions 136 of FIG. 1.

After identifying a new multicast group address (e.g., the underlay group address 216 during transition from the overlay 202 to the underlay 204) the VTEP 220 may perform a routing table lookup to identify the upstream neighbor using the new group address. In a similar manner as the other network devices that receive the Mtrace request 222, the VTEP 220 may also incorporate metadata such as identifying information 224 associated with the VTEP 220 and/or identifying information 224 of the upstream neighbor. For instance, the identifying information 224 may include an IP address, a media access control (MAC) address, and/or any other information that may identify the VTEP 220. Other devices, such as the FHR 206, the underlay network device 214, the LHR 210, the source 208, and the client 212 may also have such identifying information 224 incorporated in the Mtrace request by the end of the Mtrace operation.

Additionally, the VTEP 220 may incorporate information regarding the new group address (e.g., underlay group address 216) to the Mtrace request 222 to obtain a more detailed mapping of the overlay 202, the underlay 204, and the transition therebetween (e.g., via VTEPs 220). In some implementations, each network device that receives the Mtrace request 222 may perform a search for a mapping between the multicast group address 218 of the Mtrace request 222 and any other applicable group addresses (e.g., the underlay group address 216). For instance, the network devices may scan their local instances and/or remote instances of memory 118 and/or storage 120 to find a mapping table. Alternatively, certain types and/or configurations of network devices that potentially perform a transition of the group address (e.g., serving in roles as VTEPs 220) may search for mappings between group addresses while other network devices may refrain from such searches for increased efficiency.

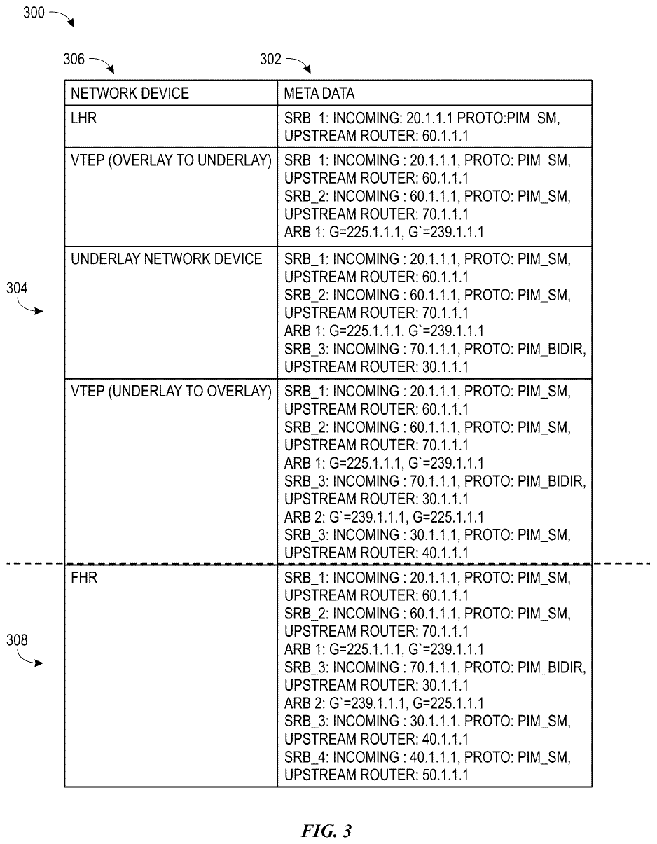

FIG. 3 is a table 300 of example metadata 302 of an Mtrace request 304 traversing network devices 306. For instance, the network devices 306 may be examples of the network devices of FIG. 1, such as intermediate network devices 106, the FHR 110, and/or the FHR 112 of FIG. 1, and may be examples of the network devices of FIG. 2, such as the LHR 210, the VTEPs 220, the underlay network device 214, and the FHR 206 of FIG. 2. As such, the network devices 306 may be part of a VxLAN topology, such as the VxLAN topology 200 of FIG. 2. As illustrated, the metadata 302 contains example identifying information, such as the identifying information 224 of FIG. 2 for the respective devices incorporated onto the metadata 302 at each respective device. The metadata may include additional information, such as time to live (TTL), timestamps, and/or other information in addition to the identifying information.

The table 300 also includes example metadata 302 of an Mtrace reply 308 corresponding to the Mtrace request 304. For instance, the Mtrace reply 308 may be an example response from an FHR, such as the FHR 206 of FIG. 2, to an Mtrace client, such as the Mtrace client 128 of FIG. 1. In some implementations, the metadata 302 of the Mtrace request 304 may be incorporated in standard response blocks (SRBs) of a packet of the Mtrace request 304. For example, the SRB of the Mtrace request 304, as well as the Mtrace reply 308, may be incorporated by each network device 306 to incorporate the identifying information 224 of the respective network device 306 and, in some implementations, the identifying information 224 of an upstream network device. For instance, the VTEP (e.g., VTEP 220) used to convert from underlay to overlay may incorporate FHR information as the next upstream network device. Additionally, in some implementations, the SRB of the Mtrace request 304 may be appended by each network device 306 to incorporate protocol information associated with that network device 306 and/or another network device 306.

Furthermore, network devices 306 that transition between the overlay 202 and underlay 204, such as a VTEP 220, may store conversion information identifying the transitions between the multicast group address 218 and the underlay group address 216. For example, the Mtrace request 304 may incorporate an augmented response block (ARB) to incorporate information beyond the identifying information 224 associated with the network devices 306. By incorporating the conversion information in the Mtrace request 304, the underlay group address 216 may be utilized to identify underlay network devices 214 and provide a more accurate mapping of the data path 108 that includes underlay and overlay information.

Additionally, in some implementations, the metadata 302 of the Mtrace request 304 may incorporate performance information associated with communications between neighboring network devices 306. For example, packet transmission/reception (Tx/Rx) counters, access control list (ACL)/boundary configurations, and/or ping information between a network device 306 and its upstream or downstream neighbor may be incorporated to the ARBs or the SRBs of the Mtrace request 304. As should be appreciated, the above-described roles of the SRB and ARB are given as examples, and the SRB and/or ARB may be utilized to store any suitable portions of the metadata 302. For example, the conversion information and/or performance information may be stored in the SRB.

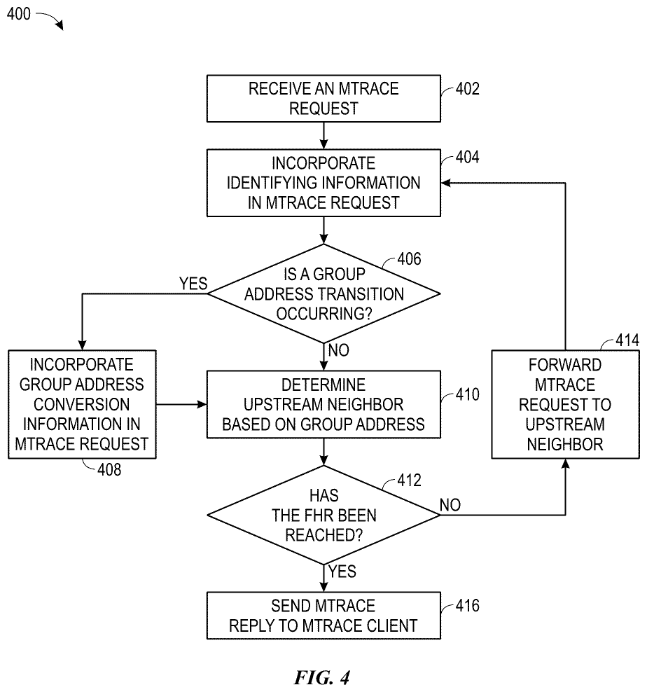

FIG. 4 is a flowchart of an example process 400 for conducting an Mtrace between a client and a source, such as the client 104 and the source 102 of FIG. 1 or the client 212 and the source 208 of FIG. 2. An Mtrace client, such as the Mtrace client 128, may initialize and send an Mtrace query, such as the Mtrace query 130. The Mtrace query is sent to an LHR, such as the LHR 112, of the client. In some implementations, an example of the Mtrace client 128 may be the LHR 112, the FHR 110, an intermediate network device 106 of the network 100 along the data path 108, or another network device. Moreover, the Mtrace client 128 may specify a multicast group address, such as the multicast group address 218, for which the Mtrace is to be carried out. A network device, such as the LHR, receives the Mtrace request (process block 402). Additionally, the network may incorporate identifying information, such as identifying information 224, associated with the network device into a Mtrace request (process block 404). As discussed above, the identifying information may include a network address, a MAC address, or other information identifying the network device and/or another network device (e.g., an upstream neighbor).

Additionally, the LHR or a network device upstream thereof may determine if a group address transition is occurring (decision block 406). For example, the LHR or other network device may act as a VTEP, such as the VTEPs 220 of FIG. 2. The LHR or other network device performs a search (e.g., via a routing table lookup) for a translation/conversion of a multicast group address (e.g., multicast group address 218) to an underlay group address (e.g., underlay group address 216) or vice versa. If a group address transition is occurring via the LHR or another network device, the LHR or network device may incorporate the conversion information regarding the transition into the Mtrace request (process block 408). For instance, the LHR or network device may use the instructions 136 in hardware and/or software to implement such a lookup and to incorporate conversion information found from the lookup into the Mtrace request.

Regardless of whether a group address transition is occurring via the LHR or network device, the LHR or network device may determine an upstream neighbor based on the group address (process block 410). For example, if the LHR or network device was not a VTEP and did not transition the group address, the LHR or network device may identify its upstream neighbor by performing a routing table lookup based on the multicast group address. Moreover, if the LHR or network device did transition the group address, the LHR or network device may identify its upstream neighbor by performing a routing table lookup based on the changed group address (e.g., the underlay group address 216). As should be appreciated, if the network device does transition from an underlay (e.g., underlay 204) to an overlay (e.g., the overlay 202), the network device may identify its upstream neighbor by performing a routing table lookup based on a multicast group address, such as the overlay group address 218, rather than the underlay group address 216. Moreover, in some implementations, the LHR or network device may incorporate the identifying information associated with the upstream neighbor in the Mtrace request.

After determining the upstream neighbor, the network device may determine if the FHR has been reached (decision block 412). For example, if the network device receiving the Mtrace request determines that the upstream neighbor is the source, the network device may be considered as the FHR. In some implementations, the network device may determine if the upstream neighbor is a source based on Link Layer Discover Protocol (LLDP) traffic, which may occur between network devices of the network, but may not occur at the interface of a source. If the FHR has not been reached, the network device may forward the Mtrace request to the upstream neighbor (process block 414). The upstream neighbor may repeat at least a portion of the process 400, such as starting at process block 404.

In other words, portions of the process 400 may be repeated as the Mtrace request is relayed along the data path from the LHR to the FHR while addressing group address transitions therebetween to obtain an Mtrace request that incorporates identifying information for each of the network devices along the data path. Likewise, the Mtrace request is incorporated with conversion information associated with one or more transitions between the overlay and the underlay. Furthermore, if the network device is the FHR, the FHR has been reached, and the FHR may send an Mtrace reply (e.g., Mtrace reply 134) indicative of the completed Mtrace request to the Mtrace client (process block 416). This transmission may be directly from the FHR to the Mtrace client and/or may be transmitted through other network device(s) acting as hops on the network(s).

The above Mtrace techniques may be used to build mappings of communication pathways in Protocol-Independent Multicast (PIM) domains, such as sparse mode (PIM-SM). For example, network devices in a PIM-SM network are unidirectional such that the upstream neighbors (e.g., previous-hop nodes) are known. Furthermore, as discussed above, in some implementations, the network may include multiple sources that provide information to the client.

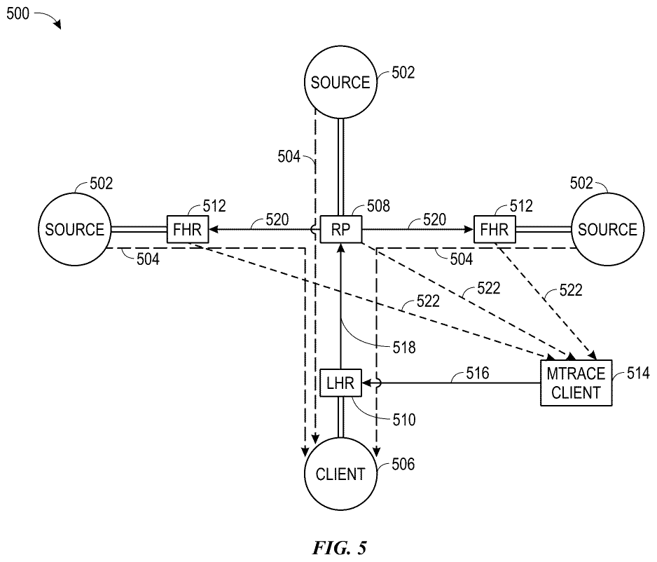

FIG. 5 is a block diagram of an example a bidirectional PIM (Bidir-PIM) network 500. The Bidir-PIM network 500 includes sources 502 that may form multiple data paths 504 to a client 506. In some scenarios, the multiple data paths 504 may converge at one or more rendezvous points (RPs) 508. Any connected network devices, such as any of the network devices of FIG. 1, such as the intermediate network devices 106, the FHR 110, or the LHR 112 of FIG. 1, may act as an RP 508. As should be appreciated, an LHR 510 of the client 506, an FHR 512 of the sources 502, and/or other network devices of the Bidir-PIM network 500 may be RPs 508. The LHR 510 may be an LHR of the client 506 like the LHRs 210 and 112 are LHRs of the clients 212 and 104, respectively. Indeed, the LHR 510 may be an example of the LHRs 210 and/or 112. Likewise, the FHR 512 may be an FHR of the source(s) 502 like the FHRs 206 and 110 are of the sources 208 and 102, respectively. Indeed, the FHR 512 may be an example of the FHRs 206 and/or 110.

While the upstream neighbor may be identifiable, such as in the routing tables of a network device, in a unidirectional network topology (e.g., PIM-SM), an RP 508 of a Bidir-PIM network 500 may not have a single identifiable upstream neighbor. In other words, identifying information that would be provided to the RP 508 from the upstream neighbor and stored in a routing table of the RP in a unidirectional network may be absent in the Bidir-PIM network 500, as there is an absence of source-specific S and G joins. A Bidir-PIM S join refers to a command where a router is joining a multi-cast group in Bidir PIM mode, and a Bidir-PIM G join refers to a message indicating an intent to join a specific multicast group and participate in the bidirectional shared tree to distribute multicast traffic within the group. As such, network devices in Bidir-PIM networks between a source 502 and an RP 508, such as the FHRs 512 of the sources 502, may not be directly traceable via Mtrace based on path information at the RP 508.

As discussed above, an Mtrace client 514 (e.g., Mtrace client 128) may send an Mtrace query 516 (e.g., Mtrace query 130) to the LHR 510 of the client 506. In some scenarios, the LHR 510 may generate an Mtrace request 518 (e.g., Mtrace request 132) and proceed as discussed above, such as via the process 400. For example, there may be a single (e.g., converged) data path 504 upstream of the LHR 510, and the LHR 510 may identify the upstream neighbor via a routing table lookup based on the multicast group address (e.g., multicast group address 218). Moreover, the Mtrace request 518 may include a unicast trace packet.

However, at an RP 508, where there may be multiple data paths 504 diverging/converging, the upstream neighbor data may not be known. As such, at an RP 508 where upstream neighbor data is absent, the unicast trace packet of the Mtrace request 518 may be converted to multicast trace packets 520 that are addressed to multiple (e.g., all) network devices interfacing with the RP 508 via the multicast group address (e.g., multicast group address 218). In other words, the multicast trace packets 520 of the Mtrace request 518 may be directed (e.g., flooded) from the RP 508 to multiple (e.g., all) incoming interfaces of the multicast routes for the multicast group address. As should be appreciated, if the RP 508 is in the underlay 204 of a VxLAN topology 200, the RP 508 may address the multicast trace packets 520 to the network devices interfacing with the RP 508 via a corresponding underlay group address (e.g., the underlay group address 216).

Network devices that receive a multicast trace packet 520 of the Mtrace request 518 may incorporate at least part of metadata (e.g., metadata 302) such as identifying information to the multicast trace packet 520 and may further direct (e.g., flood) the updated multicast trace packet 520 of the updated Mtrace request 518 to incoming interfaces of the multicast routes for the multicast group address. The multicast trace packets 520 may continue branching out from RPs 508 until reaching one or more FHRs 512 and/or one or more sources 502. In some implementations, one or more of the incoming interfaces of an RP 508 may be a source 502 (e.g., the RP 508 is an FHR). For example, an RP 508 receiving a multicast trace packet 520 may determine that a source has been reached based on Link Layer Discover Protocol (LLDP) traffic. As such, an RP 508 may be an FHR 512 for one data path 504 and an intermediate network device for another data path 504.

Once an FHR 512 is identified/reached, the FHR 512 may convert the received multicast trace packet 520 of the Mtrace request 518 to a unicast packet of an Mtrace reply 522 and send the Mtrace reply 522 to the Mtrace client 514. The Mtrace client 514 may collate the Mtrace replies 522 received for the multicast group address and build the Mtrace mapping of the Bidir-PIM network 500.

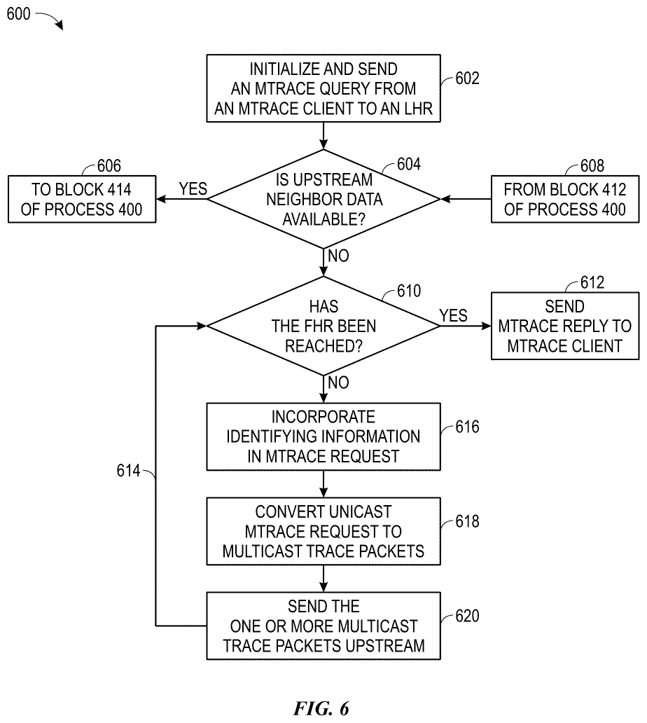

To help further illustrate, FIG. 6 is a flowchart of an example process 600 for implementing a multicast trace in a bidirectional network, such as the Bidir-PIM network 500 of FIG. 5. An Mtrace client (e.g., Mtrace client 514) may initialize and send an Mtrace query (e.g., Mtrace query 516) to an LHR (e.g., LHR 510) of the client (e.g., client 506) (process block 602). In some implementations, the Mtrace client may be the LHR, an FHR, an RP or other network device along a data path to the client or a network device outside of the network (e.g., network 100). Moreover, the Mtrace client may specify a multicast group address (e.g., multicast group address 218) for which the Mtrace is to be carried out.

Each network device, beginning with the LHR, may determine if upstream neighbor data is available (decision block 604). When no upstream neighbor data is available, the network device is a rendezvous point device. For example, upstream neighbor data may be available via a routing table lookup if the network device is not an RP (e.g., RP 508). If the upstream neighbor data is available, the process 600 may proceed to process block 414 of process 400 of FIG. 4 (process block 606) to ultimately return to decision block 604 of the process 600 if the FHR is not reached in decision block 412 of process 400 (process block 608). As such, in some implementations, portions of the process 400 and 600 may be repeated for network devices that have available upstream neighbor data. As such, the decision block 604 may be implemented between decision block 412 and process block 414 of FIG. 4.

Determining if upstream neighbor data is available may also include identifying incoming interfaces associated with the group address, such as the multicast group address 218 or underlay group address 216. As such, when no single upstream neighbor data is available for sending a unicast packet of the Mtrace request thereto, one or more incoming interfaces associated with the group address may be identified as potential upstream neighbors without the explicit upstream neighbor data. Moreover, when no such upstream neighbor data is available, the LHR or other network device may determine if an FHR (e.g., FHR 512) has been reached (process block 610), such as along one of the incoming interfaces. For example, the network device may evaluate LLDP traffic to determine if the upstream neighbor is a source. If an FHR has been reached, the FHR may send an Mtrace reply (e.g., Mtrace reply 522) indicative of the completed Mtrace request to the Mtrace client (process block 612). If the FHR has not been reached and/or if other incoming interfaces are not FHRs, the network device may incorporate identifying information (e.g., identifying information 224) in the Mtrace request—or in multicast trace packets 520 thereof if on a subsequent iteration of the loop 614 (process block 616). Additionally, the network device may convert the unicast trace packet of the Mtrace request to multicast trace packets (e.g., multicast trace packets 520)—if not completed on a previous iteration of the loop 614 (process block 618). Furthermore, the multicast trace packets may be sent or flooded multiple network devices associated with the group address) (process block 620). For example, incoming interfaces associated with the multicast group address or an underlay group address (e.g., underlay group address 216) may be flooded with the multicast trace packets to provide mapping of underlay and overlay network devices in the bidirectional network. Furthermore, the loop 614 may be iterated for each recipient of a multicast trace packet, such as until each multicast trace packet arrives at an FHR.

As may be appreciated, the current techniques provide significant value in mapping network devices along data paths between one or more sources and one or more clients. Moreover, the Mtrace mapping may be made available (e.g., transmitted, displayed, stored) for use in optimizing network activity and efficiency. For example, the mapping of a communication pathway (e.g., data path) between a source and a client can be used to improve communication efficiencies (e.g., bandwidth usage, latency) and/or troubleshooting of communication errors or degradation. For example, the mapping may be utilized to reduce repeated data streams (e.g., reducing bandwidth utilization) and/or identify shorter data paths which may reduce latency. Moreover, as discussed herein, the Mtrace mapping may incorporate identifying information associated with the network devices along data paths together with performance information such as Tx/Rx counts, ACL/boundary configurations, and/or ping information which may enhance troubleshooting procedures such as identifying malfunctioning network devices.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A network device comprising circuitry configured to:
receive a multicast trace request associated with a first multicast group address;
incorporate identifying information associated with the network device in the multicast trace request;
query one or more routing tables of the network device to determine:
a group translation between the first multicast group address and a second multicast group address; and
upstream neighbor data associated with an upstream neighbor device along a data path comprising a plurality of network devices from a data source to a data client, wherein the network device and the upstream neighbor device are network devices of the plurality of network devices along the data path, and wherein the upstream neighbor device is associated with the second multicast group address;
incorporate translation information regarding the group translation between the first multicast group address and the second multicast group address in the multicast trace request; and
send the multicast trace request with the incorporated identifying information and translation information to the upstream neighbor device.

2. The network device of claim 1, wherein the network device is configured as a virtual extensible local area network (VxLAN) tunnel endpoint (VTEP).

3. The network device of claim 2, wherein the first multicast group address is associated with an overlay of the VxLAN, and the second multicast group address is associated with an underlay of the VxLAN.

4. The network device of claim 1, wherein the circuitry of the network device is configured to incorporate the identifying information associated with the network device in the multicast trace request in a Standard Response Block (SRB) of the multicast trace request and incorporate the translation information in an Augmented Response Block (ARB) of the multicast trace request.

5. The network device of claim 1, wherein the received multicast trace request comprises identifying information corresponding to one or more downstream neighbors along the data path between the network device and the data client.

6. The network device of claim 1, wherein the circuitry of the network device is configured to incorporate network configuration data in the multicast trace request.

7. The network device of claim 1, wherein the circuitry of the network device is configured to incorporate network communication performance information in the multicast trace request.

8. The network device of claim 7, wherein the network communication performance information comprises transmitted packet counts and received packet counts.

9. The network device of claim 1, wherein the received multicast trace request comprises a unicast packet.

10. The network device of claim 9, wherein:
the network device comprises a rendezvous point device;
determining the upstream neighbor data comprises determining one or more interfaces associated with the second multicast group address;
the upstream neighbor device is connected to the network device via one incoming interface of the one or more interfaces; and
the circuitry is configured to:
convert the unicast packet of the multicast trace request to one or more multicast trace packets; and
send the one or more multicast trace packets upstream along the one or more interfaces of the network device.

11. The network device of claim 10, wherein the network device is configured as the rendezvous point device in a Bidirectional Protocol-Independent Multicast (Bidir-PIM) mode.

12. A system comprising:
a first network device comprising first circuitry configured to:
obtain a multicast trace request associated with mapping one or more data paths between one or more data sources and a data client of a first multicast group address associated with the one or more data sources;
incorporate identifying information associated with the first network device in the multicast trace request;
query one or more routing tables of the first network device to determine a group translation between the first multicast group address and a second multicast group address;
incorporate translation information regarding the group translation between the first multicast group address and the second multicast group address in the multicast trace request; and
send the multicast trace request with the incorporated translation information and the identifying information upstream along the one or more data paths to one or more intermediate network devices between the first network device and the one or more data sources.

13. The system of claim 12, wherein obtaining the multicast trace request comprises generating the multicast trace request in response to receiving a multicast trace query.

14. The system of claim 13, comprising a second network device comprising second circuitry configured to:
generate the multicast trace query;
send the multicast trace query to the first network device;
receive one or more multicast trace replies from at least one of the one or more intermediate network devices along the one or more data paths; and
generate a mapping of the one or more data paths between the first network device and the one or more intermediate network devices based on the one or more multicast trace replies.

15. The system of claim 12, wherein the first network device is configured as a virtual extensible local area network (VxLAN) tunnel endpoint (VTEP), wherein the first multicast group address is associated with an overlay of the VxLAN, and wherein the second multicast group address is associated with an underlay of the VxLAN.

16. The system of claim 12, wherein the first circuitry is configured to:
incorporate the identifying information associated with the first network device in the multicast trace request in a Standard Response Block (SRB) of the multicast trace request;
incorporate the translation information in an Augmented Response Block (ARB) of the multicast trace request; and
incorporate network communication performance information, network configuration data, or both in the ARB of the multicast trace request.

17. The system of claim 12, wherein obtaining the multicast trace request comprises receiving a unicast packet of the multicast trace request from a second network device downstream from the first network device along a data path of the one or more data paths, and wherein the first circuitry is configured to:
convert the unicast packet of the multicast trace request to one or more multicast packets; and
send the one or more multicast packets, upstream via the one or more data paths, along one or more incoming interfaces of the first network device that are associated with the second multicast group address to the one or more intermediate devices, wherein the first network device is configured in a Bidirectional Protocol-Independent Multicast (Bidir-PIM) mode.

18. A method comprising:
receiving, at a network device, a multicast trace request associated with a first multicast group address;
incorporating, by the network device, identifying information associated with the network device in the multicast trace request;
querying, by the network device, one or more routing tables of the network device to determine:
a group translation between the first multicast group address and a second multicast group address; and
an upstream neighbor device along a data path comprising a plurality of network devices from a data source to a data client, wherein the plurality of network devices comprises the network device and the upstream neighbor device, and wherein the upstream neighbor device is associated with the second multicast group address;
incorporating, by the network device, translation information regarding the group translation between the first multicast group address and the second multicast group address in the multicast trace request; and
sending, by the network device, the multicast trace request with the incorporated identifying information and translation information to the upstream neighbor device.

19. The method of claim 18, comprising incorporating network communication performance information, network configuration data, or both in the multicast trace request, wherein:
the network device is configured as a virtual extensible local area network (VxLAN) tunnel endpoint (VTEP), wherein the first multicast group address is associated with an overlay of the VxLAN, and wherein the second multicast group address is associated with an underlay of the VxLAN;
incorporating the identifying information comprises incorporating the identifying information in a Standard Response Block (SRB) of the multicast trace request;
incorporating the translation information comprises incorporating the translation information in an Augmented Response Block (ARB) of the multicast trace request; and
incorporating the network communication performance information, network configuration data, or both comprises incorporating the network communication performance information, network configuration data, or both in the ARB of the multicast trace request.

20. The method of claim 18, wherein receiving the multicast trace request comprises receiving a unicast packet, and sending the multicast trace request to the upstream neighbor device comprises sending the unicast packet to the upstream neighbor device as a rendezvous point device, the method comprising:
receiving, by the upstream neighbor device, the multicast trace request as the unicast packet;
converting, by the upstream neighbor device, the unicast packet of the multicast trace request to one or more multicast packets; and
sending, by the upstream neighbor device, the one or more multicast packets upstream along one or more incoming interfaces of the upstream neighbor device that are associated with the second multicast group address.
